(19) United States
(12) Patent Application Publication
(10) Pub. No.: US 2009/0218846 A1
(43) Pub. Date: Sep. 3, 2009

(54) TRAPPING DETECTION SEAL FOR OPENING LEAVES OF VEHICLES

(75) Inventors: Hoang-Giang Nguyen, Ris-Orangis (FR); Chaene Seyranian, Ecquevilly (FR); Jerome Jost, Le perrcy (FR)

Correspondence Address: OBLON, SPIVAK, MCCLELLAND MAIER & NEUSTADT, P.C., 1940 DUKE STREET, ALEXANDRIA, VA, 22314, US

(73) Assignee: RENAULT S. A. S, Boulogne Billancourt (FR)

(21) Appl. No.: 12/162,014

(22) PCT Filed: Jan. 24, 2007
(86) PCT No.: PCT/FR07/50684

§ 371 Date: Oct. 3, 2008

(30) Foreign Application Priority Data
Jan. 24, 2006 (FR) 0600637

(51) Int. Cl. B60J 10/08

(52) U.S. Cl. 296/146.9

(57) ABSTRACT

A trapping detection seal for opening leaves, for example motor vehicle opening leaves, of elongate shape with an elastically deformable cross section including a first cut-out region arranged between a first conducting region and a second conduction region so as to enable the two conducting regions to come into contact with one another during deformation of the seal in a first direction. A second cut-out region is arranged between the first conducting region and a third conducting region, the cross section of the seal being deformable in at least a second direction, which is different from the first direction, to enable the first conducting region to come into contact with the third conduction region during deformation of the seal in the second direction.

The invention relates to the field of trapping detection devices and methods for vehicle openings, and in particular the field of detection seals.

In this field, the U.S. Pat. No. 6,337,549 (BLEDIN) describes a capacitive sensor arranged at the top of an upright of a vehicle door to prevent the trapping of a finger when the door window is raised. The seal comprises an electrode inserted into a deformable part of the seal close to a metallic part linked to earth. An electrical device measures the capacitance between the electrode and earth. The drawback of such a capacitive seal is that it is influenced by the accidental proximity of materials other than those that the sensor is designed to detect. For example, water on the window or dead leaves can produce a variation in the capacitance between the electrode and earth, greatly disturbing the detection device.

The patent application EP-A-334 028 (BOSCH) describes a sensor for detecting the trapping of objects or parts of human bodies in the case of door windows, or roller blinds driven by an electric motor. The sensor comprises a conductive synthetic material, the electrical resistance of which can be modified by shape variation. A fault signal is triggered when the resistance leaves a predetermined range. Such a resistive device has the advantage over the capacitive sensor of measuring only the deformation of the sensor and sending a signal only from a deformation threshold.

The patent application FR-A-2 670 342 (PEUGEOT-CITROËN) describes a trapping or cutting-off detection device of a resistive seal. The resistive devices described in the above two documents have the drawback of being sensitive to deformation only in one direction. Now, in the case of a motor vehicle tailgate, it is commonplace for the fingers that need to be detected to bear on the side of the opening and not clearly perpendicularly to the seal, such that the force to which the finger must be subjected before the resistive seal detects its presence can be high.

The invention addresses the above problems, and in particular proposes a seal providing for a multidirectional trapping detection, so as to reduce the force suffered by a finger or any part of the human body trapped by the closing of a motorized opening.

According to one embodiment of the invention, the trapping detection seal for openings, in particular for motor vehicle openings, of elongate form, has an elastically deformable cross-section comprising a first hollowed-out zone arranged between a first conductive zone and a second conductive zone so as to enable the two conductive zones to come into contact with each other on deformation of the seal in a first direction. A second hollowed-out zone is arranged between the first conductive zone and a third conductive zone, the cross-section of the seal being deformable in at least one second direction, different from the first direction, to enable the first conductive zone to come into contact with the third conductive zone on deformation of the seal in the second direction.

It will be understood that such a seal, that can be deformed in at least two different directions and, in each of these directions, that can give rise to a contact between two conductive zones, will make it possible to detect forces originating, for example, from a finger, whether the latter exerts a force in one or other of the directions of deformation of the seal. This increases the directions of detection of the seal.

According to a variant, the two hollowed-out zones of the cross-section communicate.

According to another variant, the cross-section comprises an insulating zone mechanically linking the conductive zones. The insulating zone can be made of elastomer or rubber.

Advantageously, the insulating zone has four portions of lesser thickness providing articulation for the deformation of the seal.

Advantageously, the cross-section comprises a cross-shaped hollowed-out zone separating four conductive zones.

According to another variant, the cross-section comprises four lobes of compressible material corresponding to the four portions of lesser thickness.

According to a variant, the seal presents over its length at least one cross-section provided with a bead having a catching shape designed to cooperate with a chassis frame of the vehicle or with an opening of the vehicle.

According to another variant, the cross-section of the longitudinal seal can be deformed under the effect of two opposing radial forces, the direction of said forces lying within a cone of deformation which comprises at least the first and second directions.

Advantageously, the cone of deformation is symmetrically distributed relative to the bead and presents an opening angle greater than 80 degrees.

According to another variant, at least one of the conductive zones comprises a cross-section of metal wire, surrounded by a cross-section of sheathing made of polymer material charged with metallic micro-particles or charged with carbon.

According to another aspect of the invention, it relates to a trapping detection method for openings, in particular motor vehicle openings. The method comprises a step in which a contact between two conductive zones of a seal is detected and the cross-section of the seal is deformed in a direction taken from at least two possible directions of deformation.

Advantageously, the detection of the contact is made by measuring the resistance between a first conductive zone on the one hand and at least two other conductive zones on the other hand.

According to another aspect of the invention, a detection seal is used to detect the presence of a body located in the closure path of a motorized vehicle opening.

In one use of the seal, the second and third conductive zones are linked in parallel with termination resistors and with an electrical resistance measuring device so that the contact between any two conductive zones of the seal is reflected in a lowering of the measured electrical resistance by at least a threshold value, a computer then controlling a freeing sequence on the motor operating the opening.

Other characteristics and advantages of the invention will become apparent from reading the detailed description of several embodiments of the device, taken as nonlimiting examples and illustrated by the appended drawings, in which:

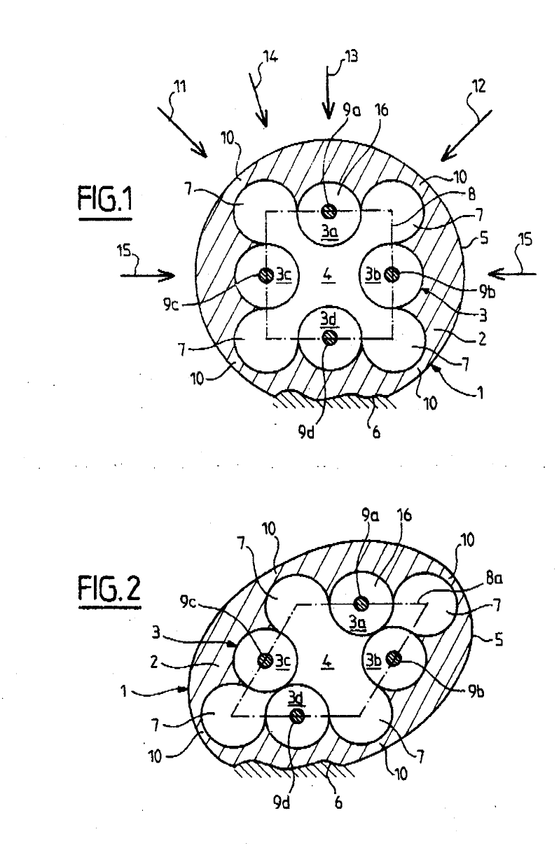

FIG. 1 is a cross-section of an inventive detection seal in the free state; and

FIG. 2 is a cross-section of a detection seal in the deformed state.

As illustrated in FIG. 1, the cross-section 1 of the trapping detection seal comprises an insulating zone 2, four conductive zones 3 and a hollowed-out zone 4 located at the center of the cross-section 1.

The insulating zone 2 is delimited externally by a substantially circular surface 5 and by a bead-shaped catching zone 6, not shown in the figure, and designed to catch the seal on a chassis frame of the vehicle or on an opening of the vehicle. The insulating zone 2 has an internal delimitation consisting of eight lobes 7 that are contiguous and substantially circular and distributed over the four sides of a square 8, the sides of the square 8 having a length roughly twice the diameter of the lobes 7. The insulating zone 2 is made of unfilled polymer, for example of rubber.

The four conductive zones 3 are of substantially circular shape and housed in the lobes 7 located in the middle of the sides of the square 8.

The hollowed-out zone 4 is cross-shaped and comprises the four lobes 7 located at the summits of the square 8. The hollowed-out zone 4 has a non-zero thickness separating two conductive zones 3, either side of each of the arms of the cross shape of the hollowed-out zone 4.

A first conductive zone 3a is located on the side of the square 8 opposite to the catching zone 6. A second conductive zone 3b is located on the right side of FIG. 1 and a third insulating zone 3c is located on the left side. A fourth conductive zone 3d comprises the catching zone 6. Each of the conductive zones 3a, 3b, 3c, 3d comprises in its center an electrical wire 9a, 9b, 9c, 9d surrounded with a sheathing 16 made of polymer filled with metallic micro-particles or even filled with carbon. The conductive zones 3 adhere to the insulating zone 2 and form a deformable single-piece assembly. The thickness of the insulating zone 2 located between the lobes 7 at the summit of the square 8 and the circular surface 5, constitutes four portions of lesser thickness 10.

A force on the external surface of the seal provokes an overall deformation of the seal illustrated in FIG. 2. In particular, this force can have a first direction 11 aligned with a diagonal of the square 8. A force in a second direction 12 corresponding to the other diagonal of the square 8 would provoke a deformation symmetrical to that illustrated in FIG. 2.

There now follows a description of the effect of the deformation according to the favored direction 11. The four portions of lesser thickness 10 behave like articulation zones, enabling the square 8 to be deformed to assume a lozenge shape 8a. During this deformation the distance separating the perimeter of the first conductive zone 3a from the perimeter of the second conductive zone 3b diminishes until the conductive zones 3a and 3b come into contact. In parallel, the conductive zones 3c and 3d also come into contact. Conversely, the distance separating the first conductive zone 3a from the third conductive zone 3c increases.

Before the perimeters of the first conductive zone 3a and of the second conductive zone 3b come into contact, the electrical resistance between the electrical wires of the conductive zones 3a and 3b is due only to the resistance of the insulating zone 2 and, for example, is greater than 10 Kohms. Immediately the perimeters of the conductive zones 3a and 3b come into contact, the resistance between the two electrical wires 9a and 9b drops sharply to a first threshold value, for example less than 5 Kohms. When the seal continues to be deformed and the deformation of the conductive sheathings 16 surrounding the electrical wires 9a and 9b is provoked, the convergence of the conductive particles of the filled polymer helps greatly to reduce the resistance between the two electrical wires 9a and 9b, to reach a value of the order of 300 ohms.

There now follows a description of the use of the detection seal to detect the presence of a body located on the closing path of a motorized opening of a motor vehicle. The opening can, in particular, be a tailgate pivoting about a horizontal hinge located in the top part of the tailgate. The opening can also be a swinging or sliding side door. Many vehicles are equipped with a motorized closure mechanism, handling the last centimeters of closure. Until the door or tailgate has reached these final centimeters, the presence of a finger in the zone separating the opening from the chassis frame of the vehicle can be tolerated by a deformable seal to enable the trapped part of the body to be removed rapidly. The trapping detection seal makes it possible to stop the final motorized convergence of the opening. The trapping detection seal covers all the area where the opening is opposite the chassis frame of the vehicle and can be fixed, either to the opening, or to the chassis frame of the vehicle. The four electrical wires 9a, 9b, 9c, 9d of the four conductive zones 3a, 3b, 3c, 3d extend all along the detection seal. A termination resistor of the order of several Kohms is located at one end of the seal and connected on one side to the ends of the electrical wires 9a and 9d and on the other side to the electrical wires 9b and 9c. On the other side of the seal, a measuring set measures the resistance between an end that is common to the electrical wires 9a and 9d and an end that is common to the electrical wires 9b and 9c. When an obstacle flattens, at at least one point, a cross-section 1 of the detection seal, the measured resistance falls below the value of the termination resistor, because the latter has been short-circuited by the contact between the electrical wires 9a and 9b coated with filled polymer. The measuring set then sends a command to a motor to suspend the closure of the opening. The measuring set can also control a freeing sequence consisting, for example, in re-opening the opening to enable the obstacle, such as the finger of a child, to be removed from the closure zone.

In a variant, the termination resistor is located on the same side of the seal as the resistance measuring device, between the electrical wires 9c and 9d, the resistance measurement being made between the ends of the wires 9a and 9b. At the opposite end of the seal, the electrical wires 9a and 9d are linked together. Similarly, the ends of the wires 9b and 9c of the same end of the seal are linked together. Thus, any contact between the first conductive zone 3a with one or other of the second and third conductive zones 3b and 3c is detected.

There now follows a description of the deformation of the seal when subjected to a compression force, in a direction lying between the first direction 11 and the second direction 12. When a force compresses the seal in a direction 13 that is roughly perpendicular to the square 8 opposite to the catching zone 6, the lobes 7 are deformed and the square 8 is transformed into an elongate polygon (bean-shaped) with the same perimeter as the square 8 until the first conductive zone 3a comes into contact with the fourth conductive zone 3d. With a force in a direction 14, lying between the first direction 11 and the third direction 13, the square 8 is transformed into a parallelogram, the large side of which is parallel to the catching zone 6 and the small inclined sides of which comprise the second and third conductive zones 3b and 3c. The deformation of the seal takes place until the conductive zone 3a comes into contact, either first with the conductive zone 3b, or simultaneously with the conductive zones 3b and 3d, or only with the conductive zone 3d. There is detection continuity whatever the direction of the force lying between the first direction 11 and the third direction 13. Because of symmetry, the same applies for the forces lying between the second direction 12 and the third direction 13. The seal presents a cone of deformation comprising at least the first and second directions 11 and 12 and presenting an opening angle of 90°.

The spring formed by the deformable seal presents a stiffness that is much higher in the transverse direction 13 than in the two favored directions of deformation that are the first direction 11 and the second direction 12. The stiffness in an intermediate direction 14 presents a value between a high stiffness in the transverse direction 13 and a low stiffness in the direction 11. The angular distribution of the stiffness of the seal presents a local minimum value for each of the two favored directions of deformation 11 and 13.

In the case where the bead for fixing onto the chassis frame, at the point of the catching zone 6, is able to withstand a torque, a horizontal force pushing the third conductive zone 3c to the right of the figures provoke a deformation that is similar to that illustrated in FIG. 2. The opening angle of the cone of deformation is 180°.

According to another embodiment variant of the seal, the latter has a flange shape with no catching bead, positioned at intervals by gluing points on the chassis frame of the vehicle. Such a catching method in the zone 6 cannot resist a torque. The seal, however, presents a cone of deformation of 90°, regardless of the angular position occupied by the catching zone relative to the four conductive zones. In this variant, the electrical configuration needed to detect a trapping situation favors the behavioral symmetry of the four conductive zones 3 and places three resistors in series between each of the four wires, the resistance measuring device being connected between an end wire and the other end wire through a fourth resistance. The contact between any two conductive zones 3 taken from the four, causes the resistance perceived by the measuring set to be lowered by at least a resistance value, which is sufficient to detect the trapping and provoke the stoppage of the motor driving the opening of the vehicle.

When the seal is provided with a fixing bead, the first conductive zone has a priority role and the electrical connection can be a star configuration where one end of the seal is fitted with three resistors linking the wire 9a to each of the second, third and fourth wires 9b, 9c and 9d. At the opposite end, the measuring device checks the resistance between the wire 9a and the three parallel-connected ends of the wires 9b, 9c and 9d.

According to another embodiment, the four lobes of the hollowed-out zone 4 located at the summit of the square 8, corresponding to the four portions of lesser thickness 10, can be filled with compressible and insulating material other than air or vacuum, such as foam. It is, however, important for the space separating two adjacent conductive zones to remain free, so as to enable their contact when the seal is deformed.

According to yet another variant, it is possible for the second 3b, third 3c and fourth 3d conductive zones to form only a single conductive assembly, substantially fixed relative to the catching bead, surrounding the first conductive zone 3a over an arc of circle, while being separated from it by a hollowed-out zone 4. The conductive assembly presents a concave surface opposite the first conductive zone 3a. The first conductive zone 3a remains joined to the insulating part 2 that can be deformed in at least the first direction 11 and in the second direction 12, and more generally, in any one of the directions lying within a cone of deformation. Whatever the direction of the compression force, the first conductive zone 3a comes into contact with the conductive assembly at any one of the contact points of the concave surface.

According to yet another variant, the hollowed-out zone 4 can be partitioned into several separate hollowed-out zones, the partition being deformable.

1-13. (canceled)

14. A trapping detection seal for openings, of elongate form having an elastically deformable cross-section, comprising:
a first hollowed-out zone arranged between a first conductive zone and a second conductive zone so as to enable the two conductive zones to come into contact with each other on deformation of the seal in a first direction; and
a second hollowed-out zone arranged between the first conductive zone and a third conductive zone, the cross-section of the seal being deformable in at least one second direction, different from the first direction, to enable the first conductive zone to come into contact with the third conductive zone on deformation of the seal in the second direction, and
wherein the cross-section comprises a catching zone located opposite the first conductive zone.

15. The seal as claimed in claim 14, wherein the two hollowed-out zones of the cross-section communicate.

16. The seal as claimed in claim 14, wherein the cross-section further comprises an insulating zone mechanically linking the conductive zones.

17. The seal as claimed in claim 16, wherein the insulating zone comprises four portions of lesser thickness providing articulation for deformation of the seal.

18. The seal as claimed in claim 17, wherein the cross-section further comprises a cross-shaped hollowed-out zone separating the conductive zones.

19. The seal as claimed in claim 17, wherein the cross-section comprises four lobes of compressible material corresponding to four portions of lesser thickness.

20. The seal as claimed in claim 14, further comprising over its length at least one cross-section comprising a bead presenting a catching shape configured to cooperate with a chassis frame of the vehicle or with an opening of the vehicle, and in which the catching zone with the bead can withstand a torque.

21. The seal as claimed in claim 14, wherein the cross-section of the longitudinal seal can be deformed under effect of two opposing radial forces, a direction of the forces lying within a cone of deformation that comprises at least the first and second directions.

22. The seal as claimed in claim 20, wherein the cone of deformation is symmetrically distributed relative to the bead and presents an opening angle greater than 80°.

23. The seal as claimed in claim 14, wherein at least one of the conductive zones comprises a cross-section of metal wire, surrounded by a cross-section of sheathing made of polymer material charged with metallic micro-particles or charged with carbon.

24. A trapping detection method for openings, comprising:
detecting a contact between two conductive zones of a seal;
catching the seal by a catching zone, one of the conductive zones being oriented facing the catching zone; and
the cross-section of the seal is deformed in a direction taken from at least two possible deformation directions.

25. The method as claimed in claim 24, wherein the detecting the contact comprises measuring resistance between a first conductive zone on and at least two other conductive zones.

26. The use of a detection seal as claimed in claim 14 for detecting trapping of a body located in the closure path of a motorized vehicle opening,
wherein the conductive zones of the seal are connected in series or in parallel with termination resistors and with an electrical resistance measuring device so that the contact between any two conductive zones of the seal is reflected in a lowering of the measured electrical resistance by at least a threshold value,
a computer then controlling the motor operating the opening in a freeing sequence.
